(19) United States
(12) Patent Application Publication
(10) Pub. No.: US 2004/0155865 A1
(43) Pub. Date: Aug. 12, 2004

(54) Ergonomic data input and cursor control device

(76) Inventor: Michael C. Swiader, Rye, NY (US)

Correspondence Address: BIRCH STEWART KOLASCH & BIRCH, PO BOX 747, FALLS CHURCH, VA, 22040-0747, US

(21) Appl. No.: 10/736,073

(22) Filed: Dec. 16, 2003

Related U.S. Application Data
(60) Provisional application No. 60/433,080, filed on Dec. 16, 2002.

(51) Int. Cl. G09G 5/08

(52) U.S. Cl. 345/161

(57) ABSTRACT

A hand-held ergonomic data input and control device is provided including a housing having several integrated components, e.g., cursor control device, programmable buttons, etc., located within the housing. An optional base docking station into which the device may be inserted is also provided. The housing may include a grip portion, at least one click button, a cursor control device that generally may take the form of a trackball, scroll wheel, or other state of the art control device, and one or more programmable buttons. The lower portion of the control device may contain a pivotable connector that permits the control device to be inserted into the base docking station. The hand-held control device may be a wireless or wired version and/or may be provided with or without the optional base docking station.

### CROSS-REFERENCES TO RELATED APPLICATIONS

This nonprovisional application claims priority under 35 U.S.C. § 119(a) on U.S. Provisional Application No. 60/433,080 filed on Dec. 16, 2002, the entirety of which is hereby incorporated by reference.

### BACKGROUND OF THE INVENTION

1. Field of the Invention

The present invention relates to data input and cursor control devices, and more particularly to an ergonomic data input and cursor control device which may be hand held or situated in a base docking station for many uses including entering and manipulating data, controlling the cursor of existing devices or accompanying systems requiring data input or mechanical control devices. The present invention provides a comfortable, efficient and convenient manner of controlling data input and cursor control for a variety of systems and hardware.

2. Description of the Background Art

The use of data input and cursor control devices, including computer mouse systems, is well known in the background art. Several data input and/or cursor control devices have been available in the background art that provide manual data input and/or cursor control for a device or system. These devices of the background art include various combinations and ornamental arrangements of trackballs, scroll bars and additional input buttons at various positions on the control device. In addition, ergonomic grips for a users hand have also been employed in the devices of the background art.

For example, U.S. Design Patent Nos. Des. 363,710 (Mateus et al.); Des. 368,901 (Currid); Des. 458,261 S (Tsai); and Des. 372,231 (Huang), the entirety of each of which are hereby incorporated by reference, show various hand-held control devices of the background art that have contoured grips and employ various combinations of input buttons and trackballs for data input and/or cursor control.

U.S. Pat. No. 4,739,128 (Grisham); U.S. Pat. No. 5,175,534 (Thatcher); U.S. Pat. No. 5,287,090 (Grant); U.S. Pat. No. 5,296,871 (Paley); U.S. Pat. No. 5,355,147 (Lear); U.S. Pat. No. 5,503,040 (Wright); U.S. Pat. No. 5,512,892 (Corballis et al.); U.S. Pat. No. 5,648,798 (Hamling); U.S. Pat. No. 5,668,574 (Huang); and U.S. Pat. No. 6,222,526 (Holmes), the entirety of each of which are hereby incorporated by reference, describe various data input and/or cursor control devices of the background art that are intended for hand-held operation by a user with operative control of input devices, e.g., a cursor control device or trackball, with a user's thumb.

However, the present inventor has identified various shortcomings with the above-described devices of the background art. Specifically, as seen in U.S. Pat. No. 5,287,090 (Grant) and U.S. Pat. No. 5,658,798 (Hamling), a combination mouse and trackball permits a user with many of the benefits of a hand-held mouse and a thumb operated trackball. However, the user is limited to an operating surface that requires the roller ball of the mouse to be in contact with a working surface to ultimately control a display pointer or cursor.

As seen in U.S. Pat. No. 4,739,128 (Grisham); U.S. Pat. No. 5,175,534 (Thatcher); U.S. Pat. No. 5,296,871 (Paley); U.S. Pat. No. 5,355,147 (Lear); and U.S. Pat. No. 5,503,040 (Wright) provide hand-held thumb control of various switches, buttons and joysticks, but the operation of a trackball or other positional cursor control device is not available in an advantageous or comfortable position for facilitating the efficient positioning of a cursor with an operator's thumb. U.S. Pat. No. 5,512,892 (Corballis et al.); U.S. Pat. No. 5,668,574 (Huang); and U.S. Pat. No. 6,222,526 (Holmes) utilize handheld control devices that include trackballs or joysticks in a position intended for control with an operator's thumb. However, the above-identified control devices of the background art fail to provide an ergonomically gripped control device that permits simultaneous support of the device with the operator's hand and manipulation of various control elements with the operator's fingers in an efficient manner.

### SUMMARY OF THE INVENTION

The present invention overcomes the shortcomings associated with the background art and achieves other advantages not realized by the background art.

An aspect of the present invention is to provide an ergonomic data input and cursor control device.

An additional aspect of the present invention is to provide an ergonomic data input and cursor control device and base docking station construction wherein the same can be operated without the need to drag or slide the device over a flat surface or limit the user to interfacing with the device in a manner that is limited by the other designs of the background art.

An additional aspect of the present invention is to provide a device that permits the user to perform data input, cursor control functions, and data viewing from a uniquely designed device from either a hand-held position or from a base platform.

An additional aspect of the present invention is to provide an ergonomic, handheld data input and cursor control device that can be operated either with or without a base docking station.

An additional aspect of the present invention is to provide an ergonomic, handheld data input and cursor control device that can be operatively connected to a base docking station in a wireless or wired operating mode(s).

An additional aspect of the present invention is to provide an ergonomic data input and cursor control device and base docking station that may be easily and efficiently manufactured and marketed.

An additional aspect of the present invention is to provide an ergonomic data input and cursor control device with advantageous combinations and arrangements of programmable buttons, e.g., such as the “left-” and “right-” click buttons found on a computer mouse of the background art, trackballs and scroll wheels in comfortable positions for facilitating the efficient control of a cursor position or other input with a user's fingers while simultaneously gripping the data input and cursor control device with the user's hand.

One or more of these and other aspects of the present invention are accomplished by an ergonomic data input and control device comprising a housing having a grip portion being contoured to conform to a grip of a user's hand, the housing further including an upper portion, a central portion and a lower portion; at least one click button being positioned on a front side of the central portion of the housing, wherein the at least one click button is positioned on the front side in a position capable of being manipulated by fingers of the user's hand and a rear side of the central portion is contoured to a palm portion of the user's hand; a cursor control device being integrally positioned within the upper portion of the housing, wherein the cursor control device is positioned within the upper portion of the housing in a position capable of being manipulated by a thumb of the user's hand; and at least one programmable button being mounted on an upper face of the upper portion of the housing.

One or more of these and other objects are further accomplished by a hand-held ergonomic data input and control device and a base docking station, wherein the base docking station is contoured to receive and integrally fit with the hand-held ergonomic data input and control device, the hand-held ergonomic data input and control device comprising a housing having a grip portion being contoured to conform to a grip of a user's hand, the housing further including an upper portion, a central portion and a lower portion, wherein the upper portion of the housing is tapered to extend outwardly with respect to the central portion of the housing and the lower portion is contoured to integrally fit within the base docking station; at least one click button being positioned on a front side of the central portion of the housing, wherein the at least one click button is positioned on the front side in a position capable of being manipulated by fingers of the user's hand and a rear side of the central portion is contoured to a palm portion of the user's hand; a cursor control device being integrally positioned within the upper portion of the housing, wherein the cursor control device is positioned within the upper portion of the housing in a position capable of being manipulated by a thumb of the user's hand; and at least one programmable button being mounted on an upper face of the upper portion of the housing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1A is a right side view of a wired ergonomic data input and cursor control device and base docking station according to an embodiment of the present invention;

FIG. 1B is a right side view of a wireless ergonomic data input and cursor control device and base docking station according to an embodiment of the present invention;

FIG. 2A is a left side view of a wired an ergonomic data input and cursor control device without a base docking station according to an embodiment of the present invention;

FIG. 2B is a left side view of a wireless ergonomic data input and cursor control device without a base docking station according to an embodiment of the present invention;

FIG. 3A is a rear view of a wired ergonomic data input and cursor control device and base docking station according to an embodiment of the present invention;

FIG. 3B is a rear view of a wireless ergonomic data input and cursor control device and base docking station according to an embodiment of the present invention;

FIG. 4A is a front view of a wired ergonomic data input and cursor control device and base docking station according to an embodiment of the present invention; and

FIG. 4B is a front view of a wireless ergonomic data input and cursor control device and base docking station according to an embodiment of the present invention.

### DETAILED DESCRIPTION OF THE PREFERRED EMBODIMENTS

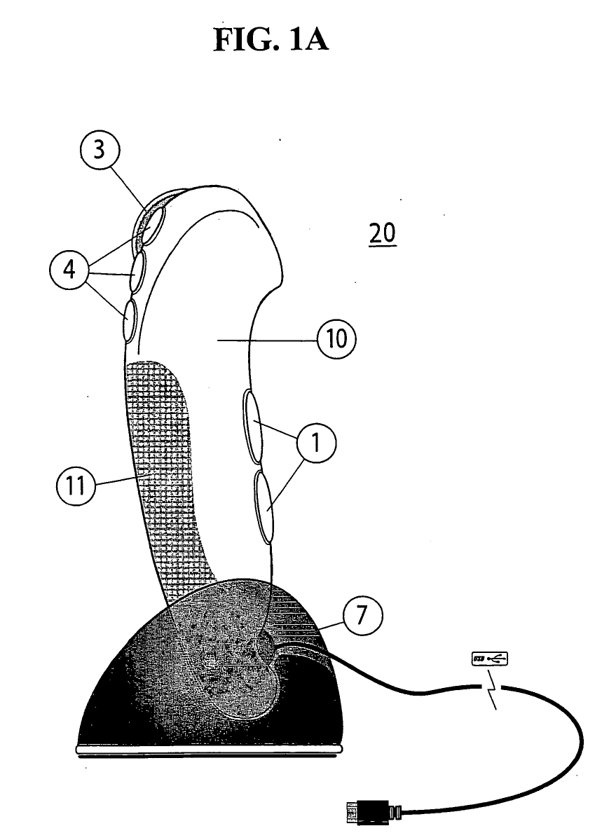

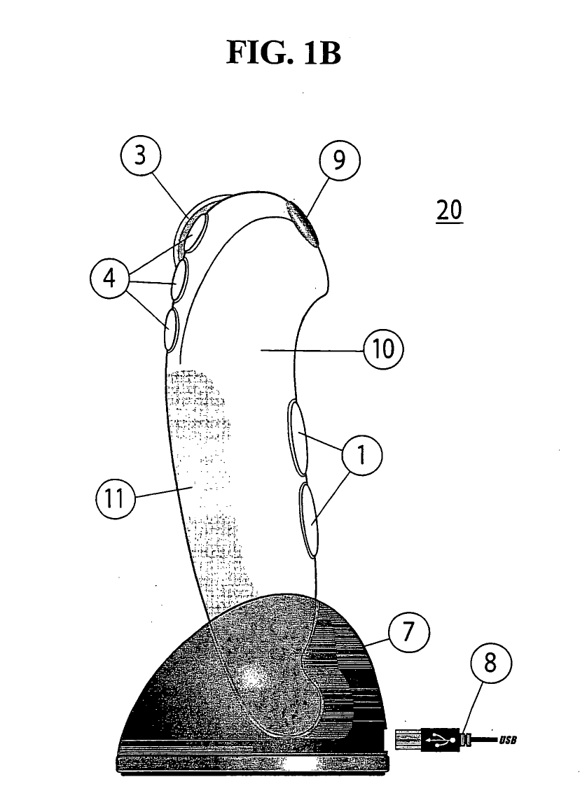

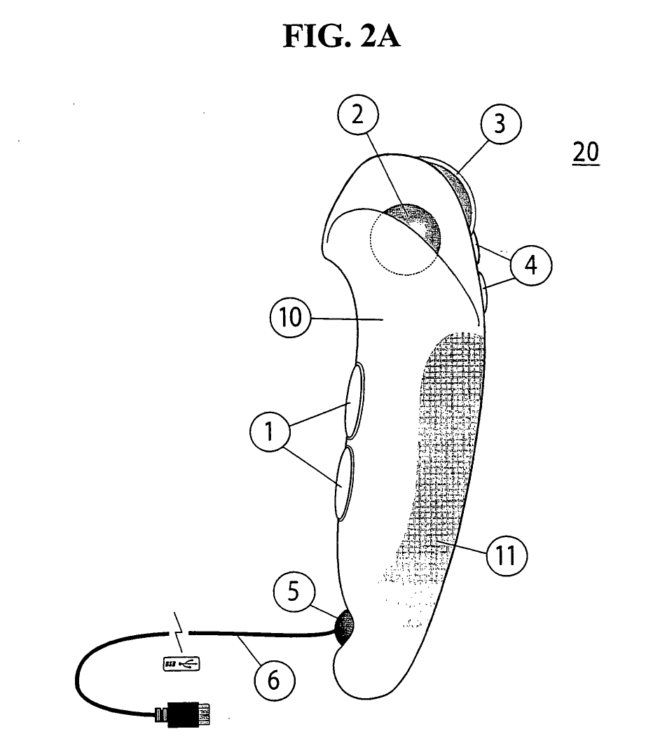

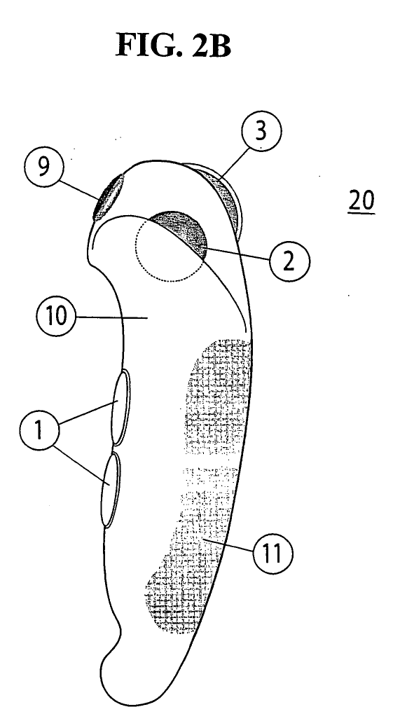

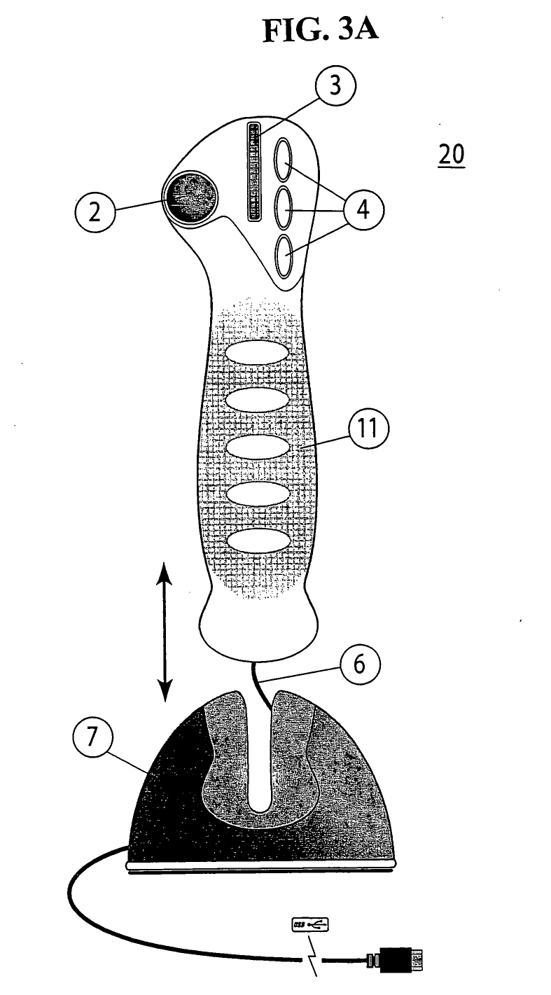

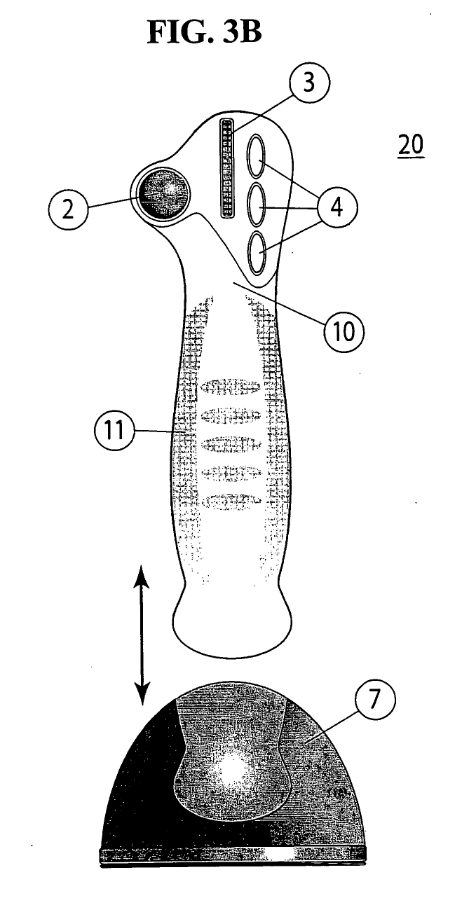

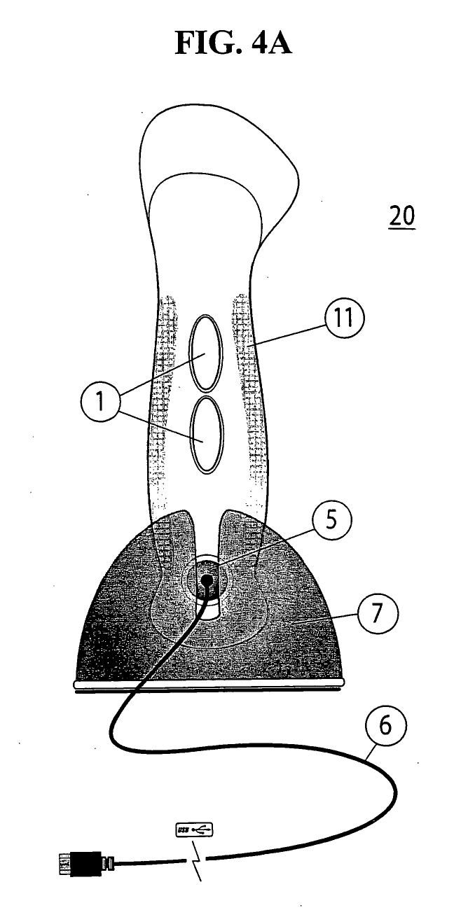

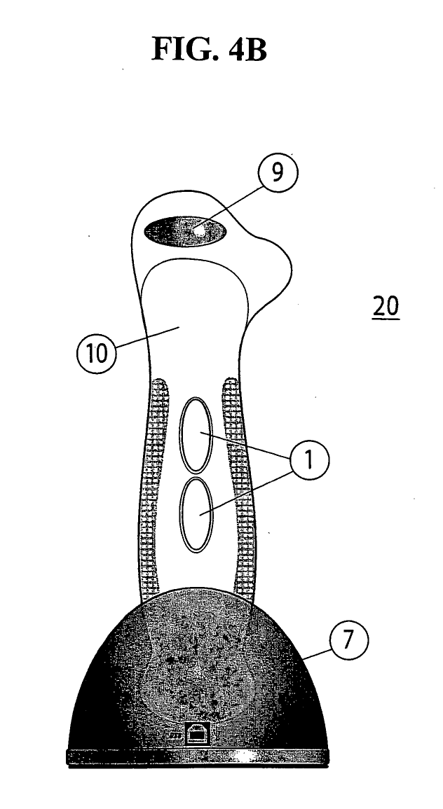

The present invention will hereinafter be described with reference to the accompanying drawings. FIG. 1A is a right side view of a wired ergonomic data input and cursor control device and base docking station according to an embodiment of the present invention. FIG. 1B is a right side view of a wireless ergonomic data input and cursor control device and base docking station according to an embodiment of the present invention. FIG. 2A is a left side view of a wired an ergonomic data input and cursor control device without a base docking station according to an embodiment of the present invention. FIG. 2B is a left side view of a wireless ergonomic data input and cursor control device without a base docking station according to an embodiment of the present invention. FIG. 3A is a rear view of a wired ergonomic data input and cursor control device and base docking station according to an embodiment of the present invention. FIG. 3B is a rear view of a wireless ergonomic data input and cursor control device and base docking station according to an embodiment of the present invention. FIG. 4A is a front view of a wired ergonomic data input and cursor control device and base docking station according to an embodiment of the present invention. FIG. 4B is a front view of a wireless ergonomic data input and cursor control device and base docking station according to an embodiment of the present invention.

FIG. 1A is a right side view of a wired ergonomic data input and cursor control device and base docking station according to an embodiment of the present invention. FIG. 1B is a right side view of a wireless ergonomic data input and cursor control device and base docking station according to an embodiment of the present invention. An ergonomic data input and cursor control device 20 is shown in the accompanying drawings. The data input and cursor control device 20 may be used with or without an optional base docking station 7 and/or may be a wired or wireless data input and cursor control device 20.

As seen in FIG. 1A, the data input and cursor control device may be a wired device having a flexible wired connection 8, e.g., a USB port or other connection mounted to a bottom portion of the data input and cursor control device 20 (hereinafter “control device 20). Alternatively, and as seen in FIG. 1B, the data input and cursor control device 20 may be a wireless version, e.g., with a wired connection 8 being provided only at the base docking station 7 for communication with a computer system or through an infrared communication port. One of skill in the art will appreciate that the base docking station 7 may alternatively be a wireless base docking station 7, e.g., with a wireless base docking station 7 and a wireless control device 20.

As seen in the accompanying drawings, the data input and cursor control device 20 includes an elongated, vertically extending housing 10 having a bottom portion, a central portion and an upper portion. The housing 10 generally includes several integrated components and the use of the optional base docking station 7.

As shown in the accompanying drawings, the device 20 has a generally vertical orientation or profile during use of the device and is designed to permit the user to hold the device in either hand or to use the device while it is inserted into the accompanying base docking station, e.g., similar to a joystick of the background art. The device and the base docking station may be constructed in whole or in part from, any number and combination of materials including, but not limited to, plastics, composite materials, metals, alloys and rubber either alone or in combination. In a preferred embodiment, the control device 20 and the optional base docking station 7 are constructed generally of molded plastic.

The front middle portion of the device has at least two click buttons that perform functions similar to the traditional “left-” and “right-” click mouse buttons 1 of the background art. The upper portion of the control device 20 is tapered and flared outwardly with respect to the central portion of the housing 10. In connection with the upper extent of the control device 20 is an integrated housing 10 where a track ball 2, scroll wheel 3, electrostatic touch pad and/or other state of the art cursor control device is situated. A small circular opening may exist in the upper portion of the track ball 2 housing from which a portion of the trackball 2 would protrude for manipulation by a user. Alternatively, another state of the art cursor control device may be used in place of the trackball 2 and/or scroll wheel 3.

Situated on the center or either side of the upper portion of the device is a scroll wheel 3 permitting the user to perform certain tasks with the scroll wheel 3 such as scrolling through information displays in connection with the host computing device such as web pages, documents, or other data displayed on a monitor, television screen or other display device. The scroll wheel 3 also may perform separate functions through the application of certain software. The scroll wheel 3 may be similar in design and function to scroll wheels utilized in the background art for a conventional mouse having a scroll wheel 3.

In proximity and adjacent to the scroll wheel 3, one or more programmable buttons 4 may be assigned specific tasks such as connecting the user to a particular web page, opening a specific file, or other assigned task. Three programmable buttons 4 are depicted in the accompanying figures. However, one of skill in the art will appreciate that the number of these buttons 4 may be varied according to the desired application of the control device 20.

The wired version of the control device 20 may also include a pivoting socket 5 in the lower extent of the control device 20. A wire 6 attaches the control device 20 to a host device, e.g., such as a personal computer's USB port or to a base docking station 7. The wire relays information such as the user's inputs between the control device 20 and the host computing device. The socket 5 permits the wire 6 to adjust to multiple angles to permit the user to situate the control device 20 comfortably in different positions.

The wireless version of the control device 20 may contain an RF or IR transmitter 9 or other optical sensor that relays information such as the user's inputs between the control device 20 and the host device. Associated with the transmitter 9 is a receiving device connected to a port to the computer and/or alternatively to the base docking station.

The base or lower portion of the wireless version may contain batteries, such as AA, AAA, etc., and/or a recharging system that may recharge the power supply of the wireless device when connected to the docking station 7. The separate base docking station 7 of the wireless device may connect (through sensor-wireless or through a wired connection) to the computing device and/or a separate wire may attach to a power outlet, e.g., such as an AC power outlet.

One of skill in the art will further appreciate that the control device's 20 various functions may be varied in numerous ways with the use of separate software, e.g., for controlling the functions of the programmable buttons 4. Further, the control device 20 and base docking station 7 may be used for controlling a variety of features associated with devices where a user or viewer enters data or controls a cursor to manipulate, enter data, select or interact with data including, but not limited to computers, television systems, game units, vehicles, robotic or mechanical device controls in a comfortable, efficient, and convenient manner.

The ergonomic data input and cursor control device 20 and base docking station 7 that includes a housing 10 having a contoured lower extent and an upper extent that tapers upward and outward. At least two click buttons 1 are mounted on the front of the hand held device. Also included is a cursor control device that may take the form of a trackball 2 or other state of the art cursor control device that is situated on the upper extent of the housing 10. Further, a scroll wheel 3 also may be situated on the upper extent of the housing 10. One or more buttons 4 each of which may be assigned a specific function are also situated on the upper extent of the housing 10.

Preferred embodiments of the control device 20 will be described in greater detail hereinafter with reference to the accompanying drawings. The control device 20 includes a housing 10 with several integrated components and an optional base docking station 7. The control device 20 has a generally vertical orientation designed to permit a user to hold the control device 20 in either hand or to use the device while it is inserted into the base docking station 7.

As depicted in FIGS. 1A, 1B, 2A, 2B, 4A, and 4B, the front, central portion of the device has at least two click buttons 1 that perform functions similar to the conventional “left-” and “right-” click mouse buttons of the background art. The upper portion of the device is tapered and flared outwardly with respect to the central portion of the housing 10.

As depicted in FIGS. 2A, 2B, 3A, and 3B in connection with the upper portion of the control device is an integrated housing where a track ball 2 or other state of the art cursor control device is situated. A small circular opening (see FIG. 3A) may be formed in the upper portion of the track ball housing from which a portion of the trackball 2 would protrude for manipulation by the user. Alternatively, a state of the art cursor control device may be used in place of the housing and/or trackball (not illustrated). Although the cursor control device is shown situated at the left side of the upper extent of the device, the cursor control device may be alternatively situated depending upon the configuration of the device for a left-handed or a right-handed user or in the central portion of the upper face.

FIGS. 1A, 1B, 2A, 2B, 3A, and 3B show a scroll wheel 3 in the center of the upper face of the upper portion of the control device 20 permitting the user to perform certain tasks with the scroll wheel such as scrolling through information displays in connection with the host computing device such as web pages, documents, or other data displayed on a monitor, television screen or other display device. The scroll wheel also may perform separate functions through the application of certain software. While the device may contain more than one scroll wheel, the drawings depict a single scroll wheel. However, one of skill in the art will appreciate that the device may only contain a single cursor control device or a combination of cursor controls devices, e.g., only a trackball 2, only a scroll wheel 3, a scroll wheel 3 and trackball 2, and/or an electrostatic touchpad.

While these figures depicts that the scroll wheel is situated between the cursor control device and the programmable buttons, the scroll wheel may be alternatively situated on the device depending upon the configuration of the device for a left-handed or a right-handed user.

As depicted in FIGS, 1A, 1B, 2A, 3A and 3B, in proximity and adjacent to the scroll wheel are situated one or more programmable buttons 4 that may be assigned specific tasks such as connecting the user to a particular web page, opening a specific file, or other assigned task. Three such buttons 4 are depicted in the drawings while FIG. 2A depicts two such programmable buttons 4 as the view of one such button is obstructed. The programmable buttons 4 may be situated in various locations on or in proximity to the upper extent of the device 20 depending on the configuration of the device 20 for left-handed or right-handed users. Further, one of skill in the art will appreciate that any number of one or more programmable buttons 4 may be utilized in the control device 20.

As depicted in FIGS. 2A and 4A, a pivoting socket 5 is provided in the lower portion of the control device 20 to which a wire 6 attaches the control device 20 to an external host computing device in a wired version of the control device 20. The external host computing device may be the base docking station 7 and/or another computing device such as a laptop, notebook or desktop computer. The wire 6 relays information such as the user's inputs between the device and the host computing device. The socket 5 permits the wire 6 to adjust to multiple angles to permit the user to situate the device comfortably in different positions, e.g., as also shown in FIG. 3A.

FIGS. 1B, 2B and 4B depict a wireless version of the control device 20. In the wireless version of the control device 20, a sensing device 9, e.g., an IR, RF or optical sensing port, is provided that relays information such as the user's inputs between the device and the host device (not illustrated) through the combination of transmission and receiving operations of data. A variety of combinations of transmitter(s) and/or receiving device(s) may be positioned on the control device 20, base docking station, and/or host computing device.

For illustrative purposes, the drawings depict a textured grip portion 11 which may include a combination of raised features on the device to aesthetically improve a user's gripping action of the control device 20. As seen generally in FIGS. 3A and 3B, the control-device is designed to be a hand-held device to be gripped by the palm of a user's hand. If the device shown in FIG. 3A is gripped with a user's right hand, the user's thumb will be comfortably situated to operate the trackball 2 and/or the scroll wheel 3 positioned on the upper face of the upper portion of the housing 10. In addition, the fingers of the user's gripping hand will be able to operate the click buttons 1 positioned on the front side of the central portion of the housing 10.

The device and base docking station may be configured for left-handed or right-handed users where the cursor control device 20, the scroll wheel 3 and programmable buttons 4 may be situated in different configurations. For example, only the cursor control device 20 may be situated on the left side of the upper face of the upper portion or it may be situated in the center or the right side of the upper extent of the device. In such configurations, the scroll wheel and the programmable buttons also may be situated in different positions.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ergonomic data input and control device comprising:
a housing having a grip portion being contoured to conform to a grip of a user's hand, said housing further including an upper portion, a central portion and a lower portion;
at least one click button being positioned on a front side of the central portion of the housing, wherein said at least one click button is positioned on the front side in a position capable of being manipulated by fingers of the user's hand and a rear side of the central portion is contoured to a palm portion of the user's hand;
a cursor control device being integrally positioned within the upper portion of the housing, wherein said cursor control device is positioned within the upper portion of the housing in a position capable of being manipulated by a thumb of the user's hand; and
at least one programmable button being mounted on an upper face of the upper portion of the housing.

2. The ergonomic data input and control device according to claim 1, wherein said upper portion is tapered to extend outwardly with respect to said central portion of the housing.

3. The ergonomic data input and control device according to claim 1, wherein the cursor control device is at least one of a trackball, a scroll wheel, and an electrostatic touchpad.

4. The ergonomic data input and control device according to claim 3, wherein the cursor control device is a trackball.

5. The ergonomic data input and control device according to claim 3, wherein the cursor control device is a scroll wheel positioned within and protruding from the upper face of the upper portion of the housing.

6. The ergonomic data input and control device according to claim 4, further comprising a scroll wheel being positioned within and protruding from the upper face of the upper portion of the housing.

7. The ergonomic data input and control device according to claim 1, wherein the at least one click button includes a pair of click buttons being positioned on the front side of the central portion of the housing.

8. The ergonomic data input and control device according to claim 6, wherein the at least one click button includes a pair of click buttons being positioned on the front side of the central portion of the housing.

9. The ergonomic data input and control device according to claim 8, wherein said upper portion is tapered to extend outwardly with respect to said central portion of the housing.

10. The ergonomic data input and control device according to claim 1, further comprising a power supply for wireless operation.

11. The ergonomic data input and control device according to claim 1, further comprising a base docking station, wherein said base docking station is contoured to receive and integrally fit with the lower portion of the housing.

12. The ergonomic data input and control device according to claim 1, further comprising a laser pointer.

13. The ergonomic data input and control device according to claim 9, further comprising a sensing device integrally formed with said housing for communicating input and control data between the control device and an external host computing device.

14. The ergonomic data input and control device according to claim 13, wherein said external host computing device includes a base docking station, wherein said base docking station is contoured to receive and integrally fit with the lower portion of the housing.

15. The ergonomic data input and control device according to claim 1, further comprising a sensing device integrally formed with said housing for communicating input and control data between the control device and an external host computing device.

16. The ergonomic data input and control device according to claim 15, further comprising a pivoting connector mounted on a bottom, front face of the lower portion of the housing and being connected to a wire to communicate input and control data to the external host computing device.

17. The ergonomic data input and control device according to claim 16, wherein said sensing device is an infrared or radio-frequency sensor.

18. The ergonomic data input and control device according to claim 11, wherein the base docking station further includes at least one of a click button, a programmable button, a scroll wheel, a trackball, a sensing device, a power supply, and a power supply charging device.

19. A hand-held ergonomic data input and control device and a base docking station, wherein said base docking station is contoured to receive and integrally fit with the hand-held ergonomic data input and control device, said hand-held ergonomic data input and control device comprising:
a housing having a grip portion being contoured to conform to a grip of a user's hand, said housing further including an upper portion, a central portion and a lower portion, wherein said upper portion of said housing is tapered to extend outwardly with respect to said central portion of the housing and said lower portion is contoured to integrally fit within said base docking station;
at least one click button being positioned on a front side of the central portion of the housing, wherein said at least one click button is positioned on the front side in a position capable of being manipulated by fingers of the user's hand and a rear side of the central portion is contoured to a palm portion of the user's hand;
a cursor control device being integrally positioned within the upper portion of the housing, wherein said cursor control device is positioned within the upper portion of the housing in a position capable of being manipulated by a thumb of the user's hand; and
at least one programmable button being mounted on an upper face of the upper portion of the housing.
